(19) United States
(12) Patent Application Publication
(10) Pub. No.: US 2026/0178263 A1
(43) Pub. Date: Jun. 25, 2026

(54) Wireless Audio Transmission Method and Device

(71) Applicant: ZGMICRO HEFEI CO., Ltd., Hefei (CN)

(72) Inventor: Bin Xu, Hefei (CN)

(73) Assignee: ZGMICRO HEFEI CO., Ltd., Hefei (CN)

(21) Appl. No.: 19/417,007

(22) Filed: Dec. 11, 2025

(30) Foreign Application Priority Data
Dec. 25, 2024 (CN) 2024119384401

(51) Int. Cl. G06F 3/16

(52) U.S. Cl. CPC G06F 3/165

(57) ABSTRACT

The present disclosure discloses a wireless audio transmission method and device. Communication between a central device and a peripheral device is based on at least one primary transmission link and at least one secondary transmission link within consecutive isochronous intervals. The primary transmission link is configured to transmit a primary audio data stream, and the secondary transmission link is configured to transmit a secondary audio data stream. The primary transmission link has a higher transmission priority than the secondary transmission link. Within one isochronous interval, transmission of one or more secondary audio data packets on the secondary transmission link is then performed within one or more second subevent intervals after transmission of one or more primary audio data packets on the primary transmission link is completed within one or more first subevent intervals and upon determining that that the current isochronous interval has one or more remaining time slots.

### CROSS-REFERENCE OF RELATED APPLICATIONS

The present disclosure claims priority of Chinese Patent Application No. 2024119384401 filed in China on Dec. 25, 2024, the entire contents of which is incorporated herein by reference.

### FIELD OF THE INVENTION

The present disclosure relates to the field of wireless communication technologies, and more particularly, to a method and an apparatus for wireless audio transmission.

### BACKGROUND

Wireless audio technology provides people with unrestrained freedom to enjoy calls or music, and has won widespread popularity. In particular, Bluetooth Low Energy (BLE) Audio technology based on Connected Isochronous Stream (CIS) links, Connected Isochronous Group (CIG) protocol formed by at least one CIS link, and Low Complexity Communication Codec (LC3) will deliver wireless audio services with lower power consumption, lower cost, and higher quality. Furthermore, a Higher Data Throughput (HDT) physical layer (PHY) supported by a new generation BLE specification provides higher transmission rates, e.g., 4 Mbps, 6 Mbps, and 7.5 Mbps, making it possible for BLE Audio to support High Resolution Audio (HRA) or Lossless Audio which require higher bandwidth.

However, in BLE Audio application scenarios, transmission distance, wireless signal fading, and interference in the wireless communication environment may be constantly changing. Based on the fixed coding rate, fixed PHY, and fixed link parameters of existing CIG links, it is difficult to adapt to rapidly changing wireless communication environments. Methods that adjust the coding rate, PHY, and CIG link parameters according to changes in the wireless communication environment are also difficult to adapt to rapidly changing wireless communication environments. That is, during the process of adjusting the coding rate, PHY, and link parameters, instability in communication performance and audio quality is likely to occur.

### SUMMARY

The purpose of the present disclosure is to provide a wireless audio transmission method and a wireless audio transmission apparatus to improve adaptability of wireless audio transmission to rapidly changing wireless communication environments.

In a first aspect, a wireless audio transmission method for a central device is provided according to one embodiment of the present disclosure. Communication between the central device and a peripheral device is based on at least one primary transmission link and at least one secondary transmission link within consecutive isochronous intervals. The primary transmission link is configured to transmit a primary audio data stream, and the secondary transmission link is configured to transmit a secondary audio data stream. The primary transmission link has a higher transmission priority than the secondary transmission link. The method comprises: performing transmission of one or more primary audio data packets based on the primary transmission link within one or more first subevent intervals within a current isochronous interval; and performing transmission of one or more secondary audio data packets based on the secondary transmission link within one or more second subevent intervals within the current isochronous interval after completing the transmission of the one or more primary audio data packets, and upon determining that the current isochronous interval has one or more remaining time slots. Wherein the one or more primary audio data packets are audio data packets within the primary audio data stream, and the one or more secondary audio data packets are audio data packets within the secondary audio data stream; and wherein the one or more first subevent intervals and the one or more second subevent intervals at least partially overlap in the time domain.

In a second aspect, a wireless audio transmission method for a peripheral device is provided according to one embodiment of the present disclosure. Communication between the central device and a peripheral device is based on at least one primary transmission link and at least one secondary transmission link within consecutive isochronous intervals. The primary transmission link is configured to transmit a primary audio data stream, and the secondary transmission link is configured to transmit a secondary audio data stream. The primary transmission link has a higher transmission priority than the secondary transmission link. The method comprises, receiving one or more primary audio data packets transmitted by the central device based on the primary transmission link within one or more first subevent intervals within a current isochronous interval; and receiving one or more secondary audio data packets transmitted by the central device based on the secondary transmission link within one or more second subevent intervals within the current isochronous interval: after completing reception of the one or more primary audio data packets and upon determining that the current isochronous interval has one or more remaining time slots. Wherein the one or more primary audio data packets are audio data packets within the primary audio data stream, and the one or more secondary audio data packets are audio data packets within the secondary audio data stream; and wherein the one or more first subevent intervals and the one or more second subevent intervals at least partially overlap in the time domain.

In a third aspect, a central device is provided according to one embodiment of the present disclosure. Communication between the central device and a peripheral device is based on at least one primary transmission link and at least one secondary transmission link within consecutive isochronous intervals. The primary transmission link is configured to transmit a primary audio data stream, and the secondary transmission link is configured to transmit a secondary audio data stream. The primary transmission link has a higher transmission priority than the secondary transmission link. The central device comprises: a first primary audio data stream transmission unit, configured to perform transmission of one or more primary audio data packets based on the primary transmission link within one or more first subevent intervals within a current isochronous interval; and a first secondary audio data stream transmission unit, configured to perform transmission of one or more secondary audio data packets based on the secondary transmission link within one or more second subevent intervals of the current isochronous interval after the first primary audio data stream transmission unit completes the transmission of the one or more primary audio data packets and upon determining that the current isochronous interval has one or more remaining time slots. Wherein the one or more primary audio data packets are audio data packets within the primary audio data stream, and the one or more secondary audio data packets are audio data packets within the secondary audio data stream; and wherein the one or more first subevent intervals and the one or more second subevent intervals at least partially overlap in the time domain.

In a fourth aspect, a peripheral device is provided according to one embodiment of the present disclosure. Communication between the central device and a peripheral device is based on at least one primary transmission link and at least one secondary transmission link within consecutive isochronous intervals. The primary transmission link is configured to transmit a primary audio data stream, and the secondary transmission link is configured to transmit a secondary audio data stream. The primary transmission link has a higher transmission priority than the secondary transmission link. The peripheral device comprises: a second primary audio data stream transmission unit, configured to receive one or more primary audio data packets transmitted by the central device based on the primary transmission link within one or more first subevent intervals within a current isochronous interval; and a second secondary audio data stream transmission unit, configured to receive one or more secondary audio data packets transmitted by the central device, based on the secondary transmission link within one or more second subevent intervals of the current isochronous interval after the primary audio data stream transmission unit completes the reception of the one or more primary audio data packets and upon determining that the current isochronous interval has one or more remaining time slots. Wherein the one or more primary audio data packets are audio data packets within the primary audio data stream, and the one or more secondary audio data packets are audio data packets within the secondary audio data stream; and wherein the one or more first subevent intervals and the one or more second subevent intervals at least partially overlap in the time domain.

In the above technical solution, because the first subevent intervals and the second subevent intervals at least partially overlap in the time domain, i.e., the primary transmission link and the secondary transmission link at least share part of the time slot resources. Meanwhile, the primary transmission link has priority in occupying time slot resources in isochronous communication. Therefore, in a rapidly changing wireless communication environment, time slot resources for the primary transmission link can be prioritized and ensured, enabling adaptive hierarchical transmission without adjusting link parameters, thereby improving the adaptability of wireless audio transmission to rapidly changing wireless communication environments.

There are many other objects, together with the foregoing attained in the exercise of the disclosure in the following description and resulting in the embodiment illustrated in the accompanying drawings.

### BRIEF DESCRIPTION OF THE DRAWINGS

These and other features, aspects, and advantages of the present disclosure will become better understood with regard to the following description, appended claims, and accompanying drawings wherein:

FIG. 1 is a schematic structural diagram of a wireless audio transmission system according to one embodiment of the present disclosure;

FIG. 2 is a schematic flowchart of a wireless audio transmission method according to one embodiment of the present disclosure;

FIG. 3 is a schematic flowchart of another wireless audio transmission method according to one embodiment of the present disclosure;

FIG. 4 is a schematic block diagram of a central device according to one embodiment of the present disclosure;

FIG. 5 is a schematic block diagram of an encoder inside the central device according to one embodiment of the present disclosure;

FIG. 6 is a schematic block diagram of a peripheral device according to one embodiment of the present disclosure;

FIG. 7 is a schematic block diagram of a decoder inside the peripheral device according to one embodiment of the present disclosure;

FIG. 8 is a schematic diagram of a time slot structure of an HCIG link according to one embodiment of the present disclosure; and

FIG. 9 is a schematic structural diagram of an electronic device according to one embodiment of the present disclosure.

### DETAILED DESCRIPTION

The detailed description of the disclosure is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the disclosure. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the disclosure do not inherently indicate any particular order nor imply any limitations in the disclosure.

To clarify the objectives, technical solutions, and advantages of the embodiments of the present disclosure, the technical solutions in the embodiments of the present disclosure will be clearly and completely described below in conjunction with the accompanying drawings in the embodiments of the present disclosure. Obviously, the described embodiments are part of the embodiments of the present disclosure, rather than all the embodiments. Based on the embodiments of the present disclosure, all other embodiments obtained by those skilled in the art without making creative efforts shall fall within the protection scope of the present disclosure.

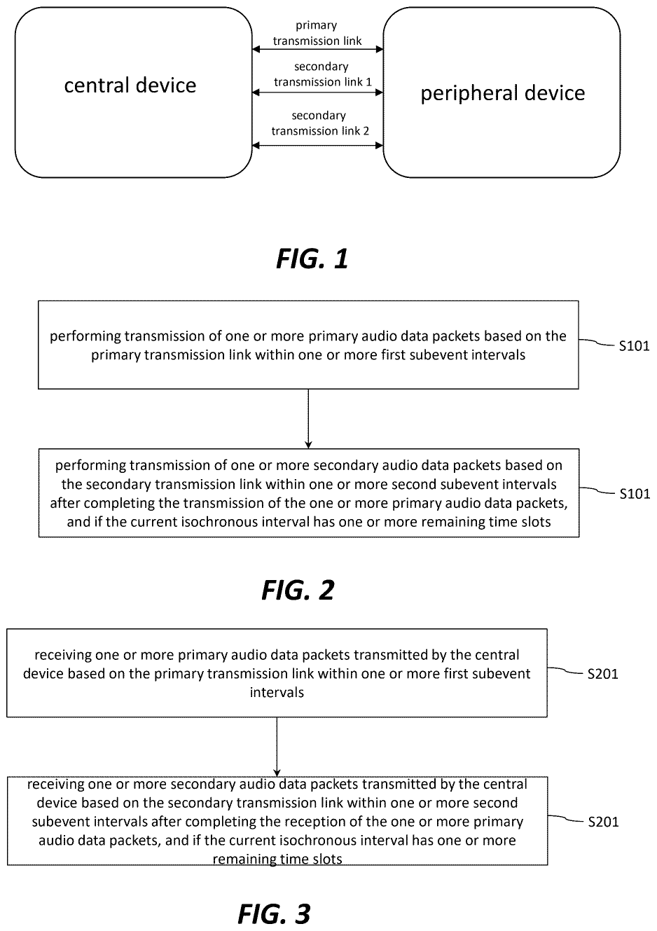

This embodiment of the present disclosure provides a wireless audio transmission method. FIG. 1 shows a schematic architectural diagram of a wireless audio transmission system comprising a central device and a peripheral device according to this embodiment. This wireless audio transmission system employs the wireless audio transmission method of this embodiment.

Herein, the central device may be various suitable devices such as: a mobile phone, a media player (e.g., MP3, MP4, etc.), a tablet computer, a laptop computer, a television, or a smart watch, wherein the central device is capable of providing at least audio source output.

The peripheral device may be various suitable devices such as a Bluetooth headset, a Bluetooth speaker, wireless glasses, a wireless wristband, a wireless watch, a wireless vehicle-mounted device, an augmented reality (AR) device, a virtual reality (VR) device, etc. The peripheral device is capable of receiving at least wireless audio from the central device. In some specific embodiments, the peripheral device may also be used for playing an audio stream.

FIG. 2 is a schematic flowchart of a wireless audio transmission method for a central device according to this embodiment. Communication between the central device and the peripheral device is performed based on at least one primary transmission link and at least one secondary transmission link within consecutive isochronous intervals. The primary transmission link is configured to transmit a primary audio data stream, and the secondary transmission link is configured to transmit a secondary audio data stream. The primary transmission link has a higher transmission priority than the secondary transmission link.

The method comprises, within a current isochronous interval: S101: performing transmission of one or more primary audio data packets based on the primary transmission link within one or more first subevent intervals within a current isochronous interval; S102: upon determining that transmission of the primary audio data packets has been completed and the current isochronous interval still has remaining time slots, performing transmission of one or more secondary audio data packets based on the secondary transmission link within one or more second subevent intervals within the current isochronous interval.

The one or more primary audio data packets are audio data packets within the primary audio data stream. The one or more secondary audio data packets are audio data packets within the secondary audio data stream.

It should be understood that the current isochronous interval is one isochronous interval among the consecutive isochronous intervals.

In this embodiment, one isochronous interval is configured with one or more first subevent intervals corresponding to the primary transmission link, and is also configured with one or more second subevent intervals corresponding to the secondary transmission link, wherein the one or more first subevent intervals and the one or more second subevent intervals at least partially overlap in the time domain.

The first subevent intervals and the second subevent intervals at least partially overlapping in the time domain means that the primary transmission link and the secondary transmission link at least share part of the time slot resources. Meanwhile, the primary transmission link has priority in occupying time slot resources in isochronous communication. Therefore, in a rapidly changing wireless communication environment, the time slot resources for the primary transmission link can be prioritized and ensured, enabling adaptive hierarchical transmission without adjusting link parameters, thereby improving the adaptability of wireless audio transmission to rapidly changing wireless communication environments.

It should be understood that the number of secondary transmission links can be configured according to specific application scenarios. For example, it can be a secondary transmission link 1 and a secondary transmission link 2 as shown in FIG. 1, or it can be other numbers of secondary transmission links. This application does not specifically limit this.

In some specific embodiments, when there are multiple secondary transmission links, all secondary transmission links may be configured to have the same transmission priority. For example, the second subevent intervals within one isochronous interval may be configured to correspond to the respective secondary transmission links. Thus, after completing the transmission of one or more primary audio data packets on the primary transmission link and upon determining that the current isochronous interval still has one or more remaining time slots, transmission of one or more secondary audio data packets is performed on the corresponding secondary transmission link based on the correspondence between the second subevent intervals within the remaining time slots and the secondary transmission links.

In other specific embodiments, when there are multiple secondary transmission links, each secondary transmission link may be configured with a different transmission priority, so that within one or more second subevent intervals in the remaining time slots of the current isochronous interval, transmission of one or more secondary audio data packets on the secondary transmission link with a higher transmission priority is completed first.

Typically in wireless transmission, such as Bluetooth audio transmission, a link offset value is configured to coordinate start times between multiple links, help synchronize the peripheral device and the central device of the links, and ensure that packets are accurately transmitted and received within predetermined times, thereby optimizing transmission efficiency and accuracy. In this embodiment, the offset value of the secondary transmission link is greater than or equal to the sum of the duration of the first subevent interval and the offset value of the primary transmission link.

One first subevent interval may comprise: a first transmission time slot, a first reception time slot, a first time of inter-frame space (T_IFS: Time of Inter Frame Space), and a first time of minimum slot space (T_MSS: Time of Minimum Slot Space) for the central device on the primary transmission link. It should be understood that, for the peripheral device, the first transmission time slot corresponds to a third reception time slot for the peripheral device on the primary transmission link, and the first reception time slot corresponds to a third transmission time slot for the peripheral device on the primary transmission link. In some specific embodiments, based on the offset value of the primary transmission link, the central device transmits the primary audio data packet to the peripheral device via the primary transmission link within the first transmission time slot of the first subevent interval. Correspondingly, the peripheral device receives the primary audio data packet within the third reception time slot and transmits a primary acknowledgment data packet to the central device within the third transmission time slot. Correspondingly, the central device receives the primary acknowledgment data packet within the first reception time slot, thereby determining whether the peripheral device correctly received the transmitted primary audio data packet and whether retransmission of the audio data packet is needed on the primary transmission link based on the reception status and acknowledgment information of the primary acknowledgment data packet.

One second subevent interval may comprise: a second transmission time slot, a second reception time slot, a second time of inter-frame space interval (T_IFS), and a second time of minimum slot space (T_MSS) for the central device on the secondary transmission link. It should be understood that, for the peripheral device, the second transmission time slot corresponds to a fourth reception time slot for the peripheral device on the secondary transmission link, and the second reception time slot corresponds to a fourth transmission time slot for the peripheral device on the secondary transmission link. In some specific embodiments, based on the offset value of the secondary transmission link, the central device transmits the secondary audio data packet to the peripheral device via the secondary transmission link within the second transmission time slot of the second subevent interval. Correspondingly, the peripheral device receives the secondary audio data packet within the fourth reception time slot and transmits a secondary acknowledgment data packet to the central device within the fourth transmission time slot. Correspondingly, the central device receives the secondary acknowledgment data packet within the second reception time slot, thereby determining whether the peripheral device correctly received the transmitted secondary audio data packet and whether retransmission of the secondary audio data packet is needed on the secondary transmission link based on the reception status and acknowledgment information of the secondary acknowledgment data packet.

Based on the relationship between the offset value of the primary transmission link and the offset value of the secondary transmission link, and the composition of the first and second subevent intervals, it can be seen that the time slot relationship of the transmission links in this embodiment is neither an Interleaved mode in the CIG link nor a Sequential mode in the CIG link. This is referred to herein as a Hierarchical mode.

In some specific embodiments, the duration of the first subevent interval may be set equal to the duration of the second subevent interval, thereby making time slot resource utilization higher.

In this embodiment, because transmission resources for the primary transmission link are prioritized, the primary audio data stream may be an audio data stream with higher importance, and the secondary audio data stream may be an audio data stream with lower importance.

It should be understood that the secondary audio data stream may be related to the primary audio data stream. For example, the secondary audio data stream may be part of the audio data of the primary audio data stream. Alternatively, the secondary audio data stream may be unrelated to the primary audio data stream. For example, the primary audio data stream may be an alarm sound or voice, and the secondary audio data stream may be background music. Specifically, the primary audio data stream used for the primary transmission link and the secondary audio data stream used for the secondary transmission link can be flexibly selected according to actual application scenarios.

For example, in a typical application scenario for multi-channel audio transmission, one audio channel can be configured to occupy one primary transmission link and one secondary transmission link. That is, multiple primary transmission links correspond to multiple audio channels respectively, and multiple secondary links also correspond to multiple audio channels respectively. Multiple audio channels can be divided in the frequency domain, or divided in the time domain through time-division multiplexing. When using time-division multiplexing, a set of primary and secondary transmission links for different audio channels may not share time slots with each other, but the primary and secondary transmission links within that one set share time slots internally. Alternatively, it can also be configured that one audio channel occupies one primary transmission link and multiple secondary transmission links, and priorities can be configured among the secondary transmission links. This allows the transmission to adaptively shed the least important audio and secondary transmission links gradually in response to changes in the communication environment. Clearly, based on the design concept of this embodiment, the primary transmission links, the secondary transmission links, and the audio data transmitted on each link can be flexibly configured.

In some specific embodiments, the wireless audio transmission method can also be used to implement high-performance wireless lossless audio transmission. Here, the method further comprises: acquiring an audio data stream to be transmitted; performing lossy compression encoding on the audio data stream to obtain the primary audio data stream comprising the primary audio data packets; and performing lossless encoding on difference data generated after the lossy compression encoding of the audio data stream, to obtain the secondary audio data stream comprising the secondary audio data packets.

Because the lossy-compressed audio data is used as the primary audio data stream transmitted on the higher-priority primary transmission link, while the difference data generated from the lossy compression of the audio data stream to be transmitted is losslessly encoded and used as the secondary audio data stream transmitted on the lower-priority secondary transmission link, high-performance wireless lossless audio transmission can be supported in near-distance wireless communication environments with less fading and interference. In far-distance wireless communication environments with greater fading and interference, the coding rate can be automatically reduced to maintain smooth audio transmission without needing channel estimation and channel quality feedback information.

In some specific embodiments, the acquiring an audio data stream to be transmitted comprises: acquiring lossless audio samples, and framing the lossless audio samples to form audio sample frames having an identical length.

In some specific embodiments, the performing lossy compression encoding on the audio data stream to obtain the primary audio data stream comprising the primary audio data packets comprises: performing lossy compression encoding on the audio sample frames to obtain the primary audio data stream.

In some specific embodiments, the performing lossless encoding on difference data generated after the lossy compression encoding of the audio data stream to obtain the secondary audio data stream comprising the secondary audio data packets comprises: decoding the primary audio data stream to obtain lossy audio samples, calculating a difference between the lossy audio samples and the lossless audio samples, and performing lossless encoding on the difference to obtain the secondary audio data stream.

Both the lossy compression encoding and the lossless encoding can employ various existing or future encoding methods suitable for this embodiment, such as LC3 encoding, WavPack, FLAC, Huffman encoding, etc.

In some specific embodiments, an asynchronous connection-oriented (ACL) link is also established between the central device and the peripheral device. The asynchronous connection-oriented link is used for at least maintaining the link or transmitting link management commands. The asynchronous connection-oriented link has a lower transmission priority than the secondary transmission link. Wherein, within one isochronous interval, communicating with the peripheral device is performed based on the asynchronous connection-oriented link after completing the transmission of the one or more primary audio data packets and the secondary audio data packets, and upon determining that the isochronous interval still has one or more remaining time slots.

In this embodiment, in order to prioritize time slot resources for audio data transmission, the transmission priority of the asynchronous connection-oriented link is configured lower than that of the secondary transmission link, allowing the links for audio data transmission (including the primary and secondary transmission links) to share time slot resources with the asynchronous connection-oriented link.

In some specific embodiments, different buffers can be used to store the primary and secondary audio data streams separately. For example, the one or more primary audio data packets to be transmitted are stored in a primary buffer, and the one or more secondary audio data packets to be transmitted are stored in a secondary buffer. In some specific embodiments, both the primary buffer and the secondary buffer can be First-In-First-Out (FIFO) buffers.

Assume one isochronous interval is configured with N first subevent intervals, wherein N is a positive integer. The completing the transmission of the one or more primary audio data packets within the current isochronous interval comprises: acquiring one primary audio data packet from the primary buffer, and transmitting the primary audio data packet within an i-th first subevent interval of the current isochronous interval; wherein i is a positive integer, and i is less than or equal to N; confirming whether the primary audio data packet is correctly received by the peripheral device, and deleting the primary audio data packet from the primary buffer upon correct reception; confirming whether there are one or more remaining primary audio data packets in the primary buffer, and confirming whether the current isochronous interval has one or more remaining time slots; transmitting one of the one or more remaining primary audio data packets in the primary buffer within an (i+1)-th first subevent interval of the current isochronous interval if there are one or more remaining primary audio data packets in the primary buffer and the current isochronous interval has one or more remaining first subevent intervals; and stopping the transmission of one or more primary audio data packets within the current isochronous interval if there are no remaining primary audio data packets in the primary buffer, or if the i-th first subevent interval is an N-th first subevent interval of the current isochronous interval.

For example, if N=6, and the primary buffer stores 1 primary audio data packet (i.e., the number of primary audio data packets to be transmitted in the current isochronous interval is 1), then the primary audio data packet is transmitted within the 1st (i=1) first subevent interval of the current isochronous interval. If it is confirmed that the peripheral device correctly received the primary audio data packet, the primary audio data packet is deleted from the primary buffer. At this point, there are no remaining primary audio data packets in the primary buffer, so the transmission of one or more primary audio data packets within the current isochronous interval is complete. If it is confirmed that the peripheral device did not receive it correctly, the primary audio data packet is retransmitted in the 2nd (i=2) first subevent interval of the current isochronous interval. Since N=6, the primary audio data packet can be transmitted up to 6 times within the current isochronous interval until it is correctly received, or until the time slot resources of all 6 first subevent intervals are used.

As another example, let N=6, and the primary buffer stores 2 primary audio data packets (e.g., Packet A and Packet B), i.e., the number of primary audio data packets to be transmitted in the current isochronous interval is 2. At this point, the first primary audio data packet, Packet A, is transmitted within the 1st (i=1) first subevent interval of the current isochronous interval. If it is confirmed that the peripheral device correctly received Packet A, Packet A is deleted from the primary buffer. The primary buffer then still contains Packet B, so Packet B is transmitted within the 2nd (i=2) first subevent interval of the current isochronous interval. If Packet B is not correctly received by the peripheral device, Packet B is retransmitted in subsequent 3rd to 6th first subevent intervals until it is correctly received, or until the time slot resources of the first subevent intervals within the current isochronous interval are used up. If it is confirmed that the peripheral device did not correctly receive Packet A, similarly to the previous example, Packet A is retransmitted in subsequent 2nd to 6th first subevent intervals until it is correctly received, or until the time slot resources of the first subevent intervals within the current isochronous interval are used up. If transmitting Packet A occupies all the time slot resources of the first subevent intervals in the current isochronous interval, then Packet B will not be transmitted within the current isochronous interval.

Assume one isochronous interval is configured with M second subevent intervals, wherein M is a positive integer. The completing the transmission of the one or more secondary audio data packets within the current isochronous interval comprises: determining that a j-th second subevent interval within the current isochronous interval can be used to transmit the secondary audio data packet based on the remaining time slots of the current isochronous interval after completing the transmission of the one or more primary audio data packets, and the offset value of the secondary transmission link, wherein j is a positive integer, and j is less than or equal to M; acquiring one secondary audio data packet from the secondary buffer, and transmitting the secondary audio data packet within the j-th second subevent interval; confirming whether the secondary audio data packet is correctly received by the peripheral device, and deleting the secondary audio data packet from the secondary buffer upon correct reception; confirming whether there are one or more remaining secondary audio data packets in the secondary buffer, and confirming whether the current isochronous interval has one or more remaining time slots; transmitting one of the one or more remaining secondary audio data packets in the secondary buffer within a (j+1)-th second subevent interval of the current isochronous interval if there are one or more remaining secondary audio data packets in the secondary buffer and the current isochronous interval has one or more remaining second subevent intervals; and stopping the transmission of one or more secondary audio data packets within the current isochronous interval if there are no remaining secondary audio data packets in the secondary buffer, or if the j-th second subevent interval is an M-th second subevent interval of the current isochronous interval.

It should be understood that both the time slot resource occupation of the primary transmission link and the offset value of the secondary transmission link may affect which second subevent interval (starting from which one) within the current isochronous interval can have its time slot resources used for transmitting secondary audio data packets.

Based on the above configuration, the central device can determine whether the transmission of the audio data packets within the current isochronous interval is completed by combining the status of correct reception of audio data packets by the peripheral device and the control of deletion/retention operations of audio data packets in the buffers.

It should be understood that other methods can also be used to implement the completing the transmission of the primary or secondary audio data packets within the current isochronous interval. For example, it can be pre-set that only 1 primary or secondary audio data packet is transmitted per isochronous interval, so the end of audio data packet transmission within the current isochronous interval is determined solely based on the acknowledgment status from the peripheral device.

Based on the above settings, the central device and the peripheral device can adaptively complete the hierarchical transmission of the primary and secondary transmission links.

As shown in FIG. 3, one embodiment of the present disclosure further provides a wireless audio transmission method for the peripheral device shown in FIG. 1. Communication between the peripheral device and a central device is based on at least one primary transmission link and at least one secondary transmission link within consecutive isochronous intervals. The primary transmission link is configured to transmit a primary audio data stream, and the secondary transmission link is configured to transmit a secondary audio data stream. The primary transmission link has a higher transmission priority than the secondary transmission link.

The method comprises: S201: receiving one or more primary audio data packets transmitted by the central device based on the primary transmission link within one or more first subevent intervals within a current isochronous interval; S202: receiving one or more secondary audio data packets transmitted by the central device based on the secondary transmission link within one or more second subevent intervals within the current isochronous interval after completing the reception of the one or more primary audio data packets, and upon determining that the current isochronous interval has one or more remaining time slots. The one or more secondary audio data packets are audio data packets within the secondary audio data stream. The one or more primary audio data packets are audio data packets within the primary audio data stream.

It should be understood that the current isochronous interval is one isochronous interval among the consecutive isochronous intervals.

In this embodiment, one isochronous interval is configured with one or more first subevent intervals corresponding to the primary transmission link, and is also configured with one or more second subevent intervals corresponding to the secondary transmission link, wherein the one or more first subevent intervals and the one or more second subevent intervals at least partially overlap in the time domain.

Furthermore, one first subevent interval comprises a third reception time slot, a third transmission time slot, a first time of inter-frame space (T_IFS), and a first time of minimum slot space (T_MSS) for the peripheral device on the primary transmission link. It should be understood that, for the central device, the third reception time slot corresponds to the first transmission time slot for the central device on the primary transmission link, and the third transmission time slot corresponds to the first reception time slot for the central device on the primary transmission link.

One second subevent interval comprises a fourth reception time slot, a fourth transmission time slot, a second time of inter-frame space interval (T_IFS), and a second time of minimum slot space (T_MSS) for the peripheral device on the secondary transmission link. It should be understood that, for the central device, the fourth reception time slot corresponds to the second transmission time slot for the central device on the secondary transmission link, and the fourth transmission time slot corresponds to the second reception time slot for the central device on the secondary transmission link.

In this embodiment, the offset value of the secondary transmission link is greater than or equal to the sum of the duration of the first subevent interval and the offset value of the primary transmission link.

In some specific embodiments, the duration of the first subevent interval may be set equal to the duration of the second subevent interval, thereby making time slot resource utilization higher.

In this embodiment, because transmission resources for the primary transmission link are prioritized, the primary audio data stream may be an audio data stream with higher importance, and the secondary audio data stream may be an audio data stream with lower importance.

It should be understood that the secondary audio data stream may be related to the primary audio data stream. For example, the secondary audio data stream may be part of the audio data of the primary audio data stream. In such cases, the peripheral device can process the received audio data based on the correlation between the primary and secondary audio data streams and use it for audio playback. Alternatively, the secondary audio data stream may be unrelated to the primary audio data stream. For example, the primary audio data stream may be an alarm sound or voice, and the secondary audio data stream may be background music. In such cases, when playing the received audio data, the peripheral device can at least improve the playback smoothness of the primary audio data stream.

In some specific embodiments, the wireless audio transmission method can also be used to implement high-performance wireless lossless audio transmission. Here, the primary audio data packets carry audio data encoded with lossy compression, and the secondary audio data packets carry losslessly encoded difference data corresponding to the primary audio data packets.

The method further comprises: decoding the primary audio data packets to obtain primary audio samples, losslessly decoding the corresponding secondary audio data packets to obtain secondary audio samples, and performing a summation calculation on the primary audio samples and the secondary audio samples to output lossless audio if all the primary audio data packets and all the secondary audio data packets respectively corresponding thereto are correctly received within a predetermined duration; decoding the primary audio data packets to obtain primary audio samples, obtaining secondary audio samples corresponding to the primary audio data packets through lossless decoding and packet loss concealment techniques, performing a summation calculation on the primary audio samples and the secondary audio samples to output repaired lossless audio if all the primary audio data packets are correctly received within a predetermined duration, but only secondary audio data packets corresponding to a portion of the primary audio data packets are correctly received, and upon determining that a packet loss probability of the secondary audio data packets is less than or equal to a predetermined value; decoding the primary audio data packets to obtain primary audio samples, and outputting the primary audio samples if all the primary audio data packets are correctly received within a predetermined duration, but only secondary audio data packets corresponding to a portion of the primary audio data packets are correctly received, and upon determining that the packet loss probability of the secondary audio data packets is greater than the predetermined value; and obtaining repaired primary audio samples through decoding and packet loss concealment techniques, and outputting the repaired primary audio samples if only a portion of the primary audio data packets are correctly received within the predetermined duration.

It should be understood that the predetermined duration and the predetermined value for packet loss probability can both be set based on specific application scenarios. This application does not impose specific limitations on these.

Based on the above configuration, this embodiment can support high-performance wireless lossless audio transmission in near-distance wireless communication environments with less fading and interference. In far-distance wireless communication environments with greater fading and interference, the coding rate can be automatically reduced to maintain smooth audio transmission without needing channel estimation and channel quality feedback information. The lossless audio or repaired lossless audio obtained by the peripheral device can be used to achieve lossless audio playback, thus obtaining high-quality audiovisual effects. In far-distance wireless communication environments with greater fading and interference, the primary audio samples or repaired primary audio samples obtained by the peripheral device can be used to achieve smooth audio playback, meeting the user's basic needs.

In some specific embodiments, an asynchronous connection-oriented link is also established between the peripheral device and the central device, the asynchronous connection-oriented link having a lower transmission priority than the secondary transmission link; wherein, within the current isochronous interval, after completing the reception of the one or more primary audio data packets and the secondary audio data packets, and upon determining that the isochronous interval still has one or more remaining time slots, communication with the central device is performed based on the asynchronous connection-oriented.

In some specific embodiments, one isochronous interval can be configured with N first subevent intervals, wherein N is a positive integer. The completing the reception of the one or more primary audio data packets within the current isochronous interval comprises: receiving one primary audio data packet transmitted by the central device within an i-th first subevent interval of the current isochronous interval; wherein i is a positive integer, and i is less than or equal to N; confirming whether there are more primary audio data packets to be received within the current isochronous interval, and confirming whether the current isochronous interval has one or more remaining time slots; receiving one primary audio data packet transmitted by the central device within an (i+1)-th first subevent interval of the current isochronous interval if there are more primary audio data packets to be received within the current isochronous interval and the current isochronous interval has one or more remaining first subevent intervals; and stopping reception of primary audio data packets within the current isochronous interval if there are no more primary audio data packets to be received within the current isochronous interval, or if the i-th first subevent interval is an N-th first subevent interval of the current isochronous interval.

In some specific embodiments, one isochronous interval can be configured with M second subevent intervals. The completing the reception of the one or more secondary audio data packets within the current isochronous interval comprises: determining that a j-th second subevent interval within the current isochronous interval can be used to receive a secondary audio data packet based on remaining time slots of the current isochronous interval and an offset value of the secondary transmission link after completing the reception of the one or more primary audio data packets; receiving a secondary audio data packet within the j-th second subevent interval; confirming whether there are more secondary audio data packets to be received within the current isochronous interval, and confirming whether the current isochronous interval has one or more remaining time slots; receiving a secondary audio data packet within a (j+1)-th second subevent interval of the current isochronous interval if there are more secondary audio data packets to be received within the current isochronous interval and the current isochronous interval has one or more remaining second subevent intervals; and stopping reception of secondary audio data packets within the current isochronous interval if there are no more secondary audio data packets to be received within the current isochronous interval, or if the j-th second subevent interval is an M-th second subevent interval of the current isochronous interval; wherein M and j are positive integers, and j is less than or equal to M.

It should be understood that the confirming whether there are more primary or secondary audio data packets to be received within the current isochronous interval can be implemented using various methods. For example, if one primary audio data packet is not received within the i-th first subevent interval, or an erroneous data packet is received, it can be considered that there are still primary audio data packets to be received. Alternatively, if one correctly received primary audio data packet within the current isochronous interval carries indication information about the total number of primary audio data packets sent in the current isochronous interval, it can also be judged based on this indication information whether there are more primary audio data packets to be received. Similarly, similar methods can be used for secondary audio data packets, which will not be elaborated here.

Based on the above settings, the peripheral device and the central device can adaptively complete the hierarchical transmission of the primary and secondary transmission links.

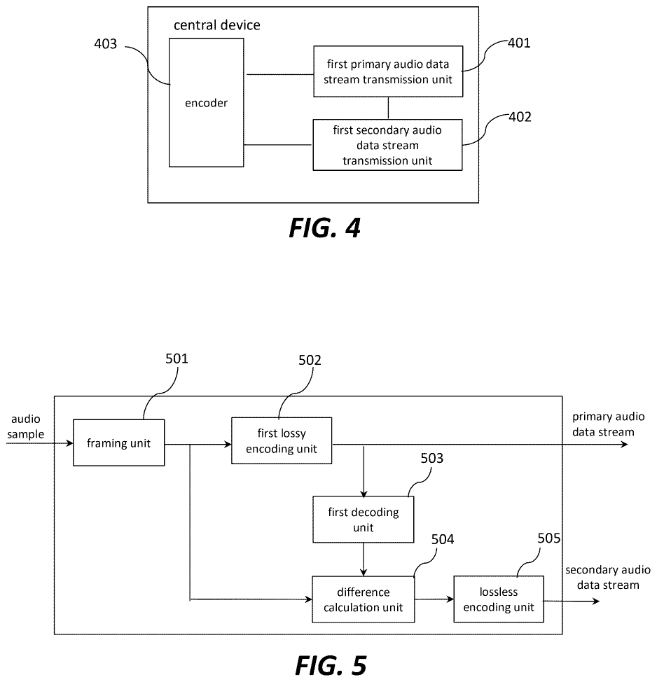

With reference to FIG. 4, this embodiment provides a central device. Communication between the central device and a peripheral device is based on at least one primary transmission link and at least one secondary transmission link within consecutive isochronous intervals. The primary transmission link is configured to transmit a primary audio data stream, and the secondary transmission link is configured to transmit a secondary audio data stream. The primary transmission link has a higher transmission priority than the secondary transmission link.

The central device comprises: a first primary audio data stream transmission unit 401, configured to perform transmission of one or more primary audio data packets based on the primary transmission link within one or more first subevent intervals within a current isochronous interval; and a first secondary audio data stream transmission unit 402, configured to perform transmission of one or more secondary audio data packets based on the secondary transmission link within one or more second subevent intervals of the current isochronous interval after the first primary audio data stream transmission unit completes the transmission of the one or more primary audio data packets and upon determining that the current isochronous interval has one or more remaining time slots; wherein the one or more primary audio data packets are audio data packets within the primary audio data stream, the one or more secondary audio data packets are audio data packets within the secondary audio data stream; and wherein the one or more first subevent intervals and the one or more second subevent intervals at least partially overlap in the time domain.

In some specific embodiments, the central device further comprises an encoder 403. The encoder 403 is configured to: receive an audio data stream to be transmitted; perform lossy compression encoding on the audio data stream to obtain one primary audio data stream comprising the primary audio data packets, and output it to the first primary audio data stream transmission unit 401; and perform lossless encoding on difference data generated after the lossy compression encoding of the audio data stream, to obtain the secondary audio data stream comprising the secondary audio data packets, and output it to the first secondary audio data stream transmission unit 402.

FIG. 5 shows a schematic diagram of a specific encoder structure. The encoder comprises a framing unit 501, a first lossy encoding unit 502, a first decoding unit 503, a difference calculation unit 504, and a lossless encoding unit 505.

The framing unit 501 is configured to receive lossless audio samples of the audio data stream to be transmitted, and frame the lossless audio samples to form audio sample frames having an identical length.

The first lossy encoding unit 502 is configured to receive the audio sample frames from the framing unit 501, perform lossy compression encoding on the audio sample frames, and output a result as the primary audio data stream.

The first decoding unit 503 is configured to receive the primary audio data stream from the first lossy encoding unit, decode the primary audio data stream, and output lossy audio samples.

The difference calculation unit 504 is configured to receive the audio sample frames from the framing unit 501 and the lossy audio samples from the first decoding unit 503, and calculate a difference between the lossy audio samples and the lossless audio samples.

The lossless encoding unit 505 is configured to perform lossless encoding on the difference calculated by the difference calculation unit 504, and output a result as the secondary audio data stream.

It should be understood that the central device can implement the wireless audio transmission of this embodiment based on the various steps and methods in the foregoing embodiments and achieve the same technical effects. For brevity, details are not repeated here.

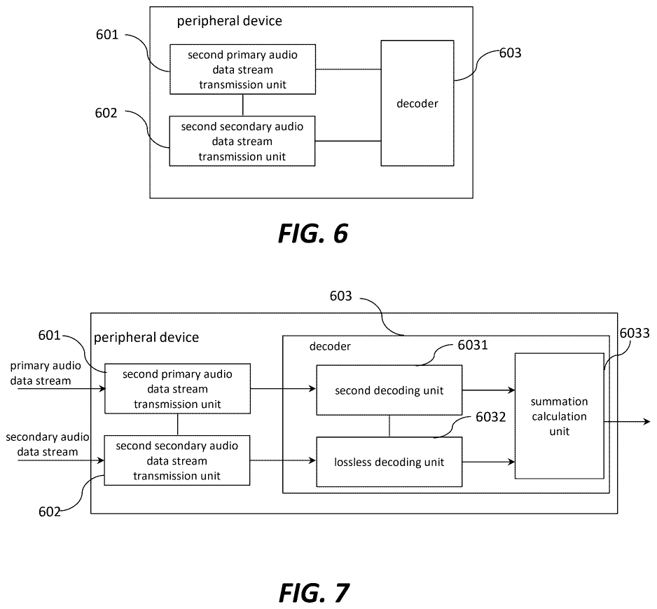

With reference to FIG. 6, this embodiment provides a peripheral device.

Communication between the peripheral device and a central device is based on at least one primary transmission link and at least one secondary transmission link within consecutive isochronous intervals. The primary transmission link is configured to transmit a primary audio data stream, and the secondary transmission link is configured to transmit a secondary audio data stream. The primary transmission link has a higher transmission priority than the secondary transmission link.

The peripheral device comprises: a second primary audio data stream transmission unit 601, configured to receive one or more primary audio data packets transmitted by the central device, based on the primary transmission link within one or more first subevent intervals within a current isochronous interval; and a second secondary audio data stream transmission unit 602, configured to receive one or more secondary audio data packets transmitted by the central device based on the secondary transmission link within one or more second subevent intervals of the current isochronous interval after the primary audio data stream transmission unit completes the reception of the one or more primary audio data packets and upon determining that the current isochronous interval has one or more remaining time slots; wherein the one or more primary audio data packets are audio data packets within the primary audio data stream, the one or more secondary audio data packets are audio data packets within the secondary audio data stream; and wherein the one or more first subevent intervals and the one or more second subevent intervals at least partially overlap in the time domain.

In some specific embodiments, the peripheral device further comprises a decoder 603, configured to implement lossless audio decoding.

FIG. 7 shows a schematic block diagram of a peripheral device with a decoder. Herein, the primary audio data packets received by the second primary audio data stream transmission unit 601 carry audio data encoded with lossy compression.

The secondary audio data packets received by the second secondary audio data stream transmission unit 602 carry losslessly encoded difference data corresponding to the primary audio data packets.

The decoder 603 comprises a second decoding unit 6031, a lossless decoding unit 6032, and a summation calculation unit 6033.

The second decoding unit 6031 is configured to decode received primary audio data packets and output primary audio samples.

The lossless decoding unit 6032 is configured to losslessly decode received secondary audio data packets corresponding to the primary audio data packets and output secondary audio samples.

The summation calculation unit 6033 is configured to perform a summation calculation on the primary audio samples and the secondary audio samples and output lossless audio.

In some specific embodiments, packet loss compensation modules can be respectively disposed between the summation calculation unit 6033 and the second decoding unit 6031, and between the summation calculation unit 6033 and the lossless decoding unit 6032. These modules are used to repair primary and secondary audio data packets respectively in case packet loss occurs and the packet loss probability is low, to obtain primary and secondary audio samples. Furthermore, in case packet loss occurs and the packet loss probability is high, packet loss compensation repair may not be performed on the secondary audio data packets. Instead, the primary audio samples output by the second decoding unit 6031, or the primary audio samples repaired by the packet loss compensation module, can be directly input to the summation calculation unit 6033. At this point, due to packet loss of the secondary audio data packets, no signal is input to the summation calculation unit 6033 from that path, so the output of the summation calculation unit 6033 is the primary audio samples or the repaired primary audio samples.

It should be understood that the peripheral device can implement the wireless audio transmission of this embodiment based on the various steps and methods in the foregoing embodiments and achieve the same technical effects. For brevity, details are not repeated here.

The following will use a typical embodiment of lossless audio transmission to describe in detail how embodiments of the present disclosure are used to implement Adaptively Hierarchical Transmission of Wireless Audio (AHTWA).

To facilitate description, some definitions in this embodiment are first explained.

The wireless audio data transmission system shown in FIG. 1 is defined as an AHTWA (Adaptively Hierarchical Transmission of Wireless Audio) system. In the AHTWA system, the central device is an audio source device, specifically, which can be a smartphone, and the peripheral device is a wireless audio terminal device, specifically, which can be a wireless headset.

The communication link used for audio transmission between the central device and the peripheral device is defined as a Hierarchical Connected Isochronous Group (HCIG) link. The HCIG contains at least two Hierarchical Connected Isochronous Stream (HCIS) links, wherein at least one primary HCIS link (corresponding to the primary transmission link shown in FIG. 1) is used for transmitting a primary audio stream, and at least one secondary HCIS link (corresponding to the secondary transmission link shown in FIG. 1) is used for transmitting a secondary audio stream. When the HCIG is used for transmitting wireless multi-channel audio, each channel is encoded into one primary audio stream and at least one secondary audio stream.

Multiple primary audio streams corresponding to multiple audio channels can be transmitted separately via multiple primary HCIS links or combined and transmitted within one primary HCIS link. Multiple secondary audio streams corresponding to multiple audio channels can be transmitted separately via multiple secondary HCIS links or combined and transmitted within one secondary HCIS link.

The codec method for lossless audio between the central device and the peripheral device is defined as a Lossless Audio Hierarchical Codec (LAHC) method. The HCIG link is used for adaptive transmission of audio data encoded with LAHC hierarchical coding between the audio source device and the wireless audio terminal device.

Without loss of generality, this embodiment uses an HCIG link composed of one primary HCIS link and one secondary HCIS link to further illustrate the characteristics of the HCIG link. That is, the HCIG established between the audio source device and the wireless audio terminal device contains two HCIS links: one primary HCIS link HCIS0, and one secondary HCIS link HCIS1.

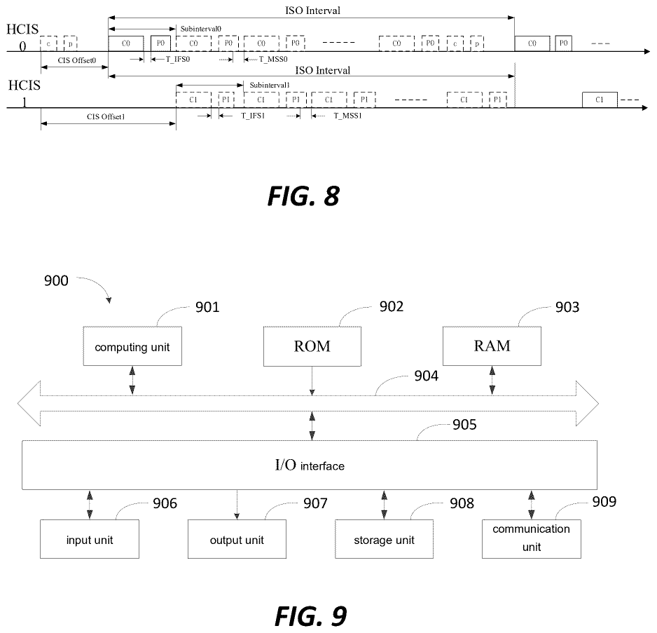

FIG. 8 shows a time slot structure diagram of an HCIG link, wherein HCIS0 is the primary HCIS link and HCIS1 is the secondary HCIS link. The characteristics of the HCIS link are the same as those of a Connected Isochronous Stream (CIS) link in the present technology. That is, both the primary and secondary transmission links can be CIS links. The difference between the HCIG link and a Connected Isochronous Group (CIG) link in the present technology lies in that the time slot relationship among the HCIS links within the HCIG is a Hierarchical mode, which is neither the Interleaved mode nor the Sequential mode in the CIG link. The HCIS links share time slots, with the primary HCIS link having priority in occupying time slots. Another difference between the HCIG and CIG links is that the physical layers (PHY) used can be different, and the subevent intervals can be different.

As shown in FIG. 8, within each Isochronous Interval (ISO Interval), the HCIS0 link occupies at least one subevent interval (Subinterval0) to transmit/receive one HCIS Protocol Data Unit (PDU), as indicated by solid-line boxes. In addition to the solid-line boxes, several dashed-line boxes represent possible retransmissions of HCIS PDUs. In FIG. 8, C0 represents the HCIS PDU sent by the HCIG central device on the HCIS0 link, and P0 represents the HCIS PDU sent by the HCIG peripheral device on the HCIS0 link. C1 in FIG. 8 represents the HCIS PDU sent by the HCIG central device on the HCIS1 link, and P1 represents the HCIS PDU sent by the HCIG peripheral device on the HCIS1 link. Both are shown with dashed-line boxes, indicating that the HCIS1 link may not transmit/receive HCIS PDUs when time slot resources are insufficient. That is, the HCIS1 link has a lower priority than the HCIS0 link.

An Asynchronous Connection-oriented Link (ACL) is also established between the audio source device and the wireless audio terminal device. In this embodiment, the asynchronous connection-oriented link can be a BLE ACL link. The boxes marked with a lowercase ‘c’ in FIG. 8 represent various PDUs sent by the HCIG central device on the BLE ACL link. The boxes marked with a lowercase ‘p’ in FIG. 8 represent various PDUs sent by the HCIG peripheral device on the BLE ACL link.

As shown in FIG. 8, the offset value of the HCIS1 link (CIS Offset1) is greater than or equal to the sum of the offset value of the HCIS0 link (CIS Offset0) and the subevent interval (Subinterval0) of the HCIS0 link. Subinterval0 equals the sum of the C0 time slot, P0 time slot, Time of Inter Frame Space (T_IFS0: Time of Inter Frame Space), and Time of Minimum Slot Space (T_MSS0: Time of Minimum Slot Space) on the HCIS0 link. The subevent interval (Subinterval1) of the HCIS1 link equals the sum of the C1 time slot, P1 time slot, T_IFS1, and T_MSS1 on the HCIS1 link. Subinterval0 and Subinterval1 may not be equal. Based on the relationship between CIS Offset1 and CIS Offset0, and the composition of Subinterval0 and Subinterval1, it can be seen that the time slot relationship among the HCIS links in the HCIG is neither the Interleaved mode nor the Sequential mode found in CIG links, and is therefore referred to as the Hierarchical mode.

Although CIS Offset1 is greater than or equal to CIS Offset0, and Subinterval0 and Subinterval1 may not be equal, having CIS Offset1 equal to CIS Offset0 and Subinterval0 equal to Subinterval1 is an optimization scheme that can make the time slot utilization of the HCIG link higher.

The structure of the Lossless Audio Hierarchical Codec (LAHC) encoder in this embodiment is as shown in FIG. 5. The first lossy encoding unit 502 can use LC3 encoding (or other lossy audio encoding), the first decoding unit 503 can use LC3 decoding (or other lossy audio decoding), and the lossless encoding unit 505 can be a WavPack encoder, FLAC encoder, Huffman encoder, etc. The workflow of the LAHC encoder is basically the same as described in the foregoing embodiments and will not be repeated here.

The structure of the LAHC decoder in this embodiment is as shown in FIG. 7. Corresponding to the audio source device side, the second decoding unit 6031 comprised in the wireless audio terminal device uses LC3 decoding (or other lossy audio decoding), and the lossless decoding unit 6032 can be a WavPack decoder, FLAC decoder, Huffman decoder, etc. Similarly, the workflow of the LAHC decoder is basically the same as described in the foregoing embodiments and will not be repeated here.

When the audio device is a smartphone and the wireless audio terminal device is a wireless headset, the following parameters can be configured to achieve lossless audio transmission between the smartphone and the wireless headset:

The sampling rate of stereo lossless audio is 48 KHz, and the quantization bit depth of each audio sample is 16 bits. Using the LAHC encoding described in this embodiment, the encoding frame length is 10 ms. The lossless encoder in the LAHC encoder structure shown in FIG. 5 is a WavPack lossless encoder. The LC3 mono encoding rate is 124 kbps, the stereo encoding rate is 248 kbps, and the encoded data per frame is 310 bytes. The WavPack stereo encoding rate is 753.6 kbps, and the encoded data per frame is 930 bytes. The primary audio stream encoded data for the two LC3-encoded channels are combined and transmitted in the HCIS0 PDU of the primary HCIS link. The secondary audio stream encoded data for the stereo or dual channels encoded by WavPack are combined and transmitted in the HCIS1 PDU of the secondary HCIS link. HCIS0 uses the BLE-HDT2 PHY with a 2 Mbps transmission rate, an air time occupation is 69+1264=1333 μs, T_IFS0=67 μs, T_MSS0=67 μs, and Subinterval0 equals 1400 μs. HCIS1 uses the BLE-HDT6 PHY with a 6 Mbps transmission rate, the air time occupation is 69+1264=1333 μs, T_IFS1=67 μs, T_MSS1=67 μs, and Subinterval1 equals 1400 μs.

For the HCIS0 link, the Number of Subevents (NSE) per isochronous interval is 5, the Burst Number (BN) is 1, the Flush Timeout (FT) equals 6, and CIS Offset0 equals 1.25 ms. For the HCIS1 link, the NSE per isochronous interval is 4, the BN is 1, the FT equals 6, and CIS Offset1 equals 2.65 ms.

The process for the audio source device to transmit LAHC-encoded lossless audio via the HCIG link is as follows. In each isochronous interval, one frame of dual-channel LC3 encoded data and one frame of dual-channel WavPack encoded data are generated, respectively combined and encapsulated into an HCIS0 PDU and an HCIS1 PDU, and stored in the First-In-First-Out (FIFO) transmission buffers of the HCIS0 link and the HCIS1 link, respectively. Within each isochronous interval, HCIS0 PDUs in the transmission buffer of the HCIS0 link are sent first via the HCIS0 link. If there are remaining time slots, HCIS1 PDUs in the transmission buffer of the HCIS1 link are then sent via the HCIS1 link until the time slots for the HCIS1 link within the current isochronous interval are used up, i.e., reaching the time slot corresponding to the maximum NSE. If sending HCIS0 PDUs uses up all time slots within the current isochronous interval, then HCIS1 PDUs are not sent.

The process for the wireless headset to receive LAHC-encoded lossless audio via the HCIG link is as follows. In each isochronous interval, HCIS0 PDUs are received first via the HCIS0 link. After successful reception is completed and upon determining that there are remaining time slots, HCIS1 PDUs are then received via the HCIS1 link until the time slots for the HCIS1 link within the current isochronous interval are used up, i.e., reaching the time slot corresponding to the maximum NSE. If receiving HCIS0 PDUs via the HCIS0 link uses up all time slots within the current isochronous interval, then HCIS1 PDUs are not received.

The methods for the wireless headset to receive and process the primary and secondary audio streams are as follows:

If the HCIS0 PDUs and HCIS1 PDUs corresponding to the encoded data generated by the primary and secondary audio streams within each isochronous interval are completely and correctly received via the HCIS0 and HCIS1 links, respectively, within the FT range, then decode and play lossless audio using the LAHC decoder as shown in FIG. 3.

If the HCIS0 PDUs corresponding to the encoded data generated by the primary audio stream within each isochronous interval are completely and correctly received via the HCIS0 link within the FT range, but the HCIS1 PDUs corresponding to the encoded data generated by the secondary audio stream are not completely and correctly received via the HCIS1 link within the FT range (i.e., there is a small probability, e.g., not less than 2%, of not being correctly received), then use Packet Loss Concealment (PLC) techniques to recover the audio samples corresponding to the lost encoded data of the secondary audio stream, and then play the PLC-repaired lossless audio.

If the HCIS0 PDUs corresponding to the encoded data generated by the primary audio stream within each isochronous interval are completely and correctly received via the HCIS0 link within the FT range, but the HCIS1 PDUs corresponding to the encoded data generated by the secondary audio stream are not completely and correctly received via the HCIS1 link within the FT range (i.e., there is a relatively high probability, e.g., greater than 2%, of not being correctly received), then only decode the encoded data of the primary audio stream and play its decoded audio samples.

If the HCIS0 PDUs corresponding to the encoded data generated by the primary audio stream within each isochronous interval are not completely and correctly received via the HCIS0 link within the FT range, then use PLC techniques to recover the audio samples corresponding to the lost encoded data of the primary audio stream, and then play the PLC-repaired audio samples of the primary audio stream.

As can be seen from the above embodiments, through LAHC encoding and the HCIG link, the AHTWA system can improve the adaptability of wireless audio transmission to rapidly changing wireless communication environments without needing channel estimation and channel quality feedback information.

According to embodiments of the present disclosure, the embodiments of the present disclosure also provide an electronic device comprising a memory and a processor. The memory stores executable code, and the processor, when executing the executable code, can be used to implement the embodiments of the present disclosure.

FIG. 9 shows a schematic block diagram of an exemplary electronic device 900 that can be used to implement embodiments of the present disclosure. As shown in FIG. 9, the device 900 comprises a computing unit 901, which can execute various appropriate actions and processing according to computer programs stored in a read-only memory (ROM) 902 or computer programs loaded from a storage unit 908 into a random access memory (RAM) 903. Various programs and data required for the operation of the device 900 can also be stored in the RAM 903. The computing unit 901, the ROM 902, and the RAM 903 are connected to each other via a bus 904. An input/output (I/O) interface 905 is also connected to the bus 904.

Multiple components in the device 900 are connected to the I/O interface 905, including: an input unit 906, such as a keyboard, mouse, etc.; an output unit 907, such as various types of displays, speakers, etc.; a storage unit 908, such as magnetic disks, optical disks, etc.; and a communication unit 909, such as network cards, modems, wireless communication transceivers, etc. The communication unit 909 allows the device 900 to exchange information/data with other devices via computer networks such as the Internet and/or various telecommunication networks.

The computing unit 901 can be various general-purpose and/or special-purpose processing components with processing and computing capabilities. Some examples of the computing unit 901 comprise, but are not limited to, a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, etc. The computing unit 901 executes the various methods and processes described above. For example, in some embodiments, the wireless audio transmission method can be implemented as a computer software program, which is tangibly contained in a machine-readable medium, such as the storage unit 908. In some embodiments, part or all of the computer programs may be loaded and/or installed onto the device 900 via the ROM 902 and/or the communication unit 909. When the computer program is loaded into the RAM 903 and executed by the computing unit 901, one or more steps of the wireless audio transmission method described above can be executed. Alternatively, in other embodiments, the computing unit 901 may be configured to execute the wireless audio transmission method in any other suitable manner (e.g., by means of firmware).

Various implementations of the systems and technologies described herein may be implemented in digital electronic circuit systems, integrated circuit systems, Field-Programmable Gate Arrays (FPGAs), Application Specific Integrated Circuits (ASICs), Application Specific Standard Products (ASSPs), System on Chips (SOCs), Complex Programmable Logic Devices (CPLDs), computer hardware, firmware, software, and/or combinations thereof. These various implementations may comprise: being implemented in one or more computer programs that can be executed and/or interpreted on a programmable system comprising at least one programmable processor. The programmable processor may be a dedicated or general-purpose programmable processor, and can receive data and instructions from a storage system, at least one input device, and at least one output device, and transmit data and instructions to the storage system, the at least one input device, and the at least one output device.

One embodiment of the present disclosure further provides a computer-readable storage medium. The method according to the embodiments of the present disclosure may be implemented in hardware, firmware, or implemented as computer code that can be recorded in a storage medium, or implemented as computer code that is originally stored in a remote storage medium or a non-transitory machine-readable storage medium and downloaded through a network to be stored in a local storage medium. Thus, the method described herein may be stored as such software processing on a storage medium using a general-purpose computer, a dedicated processor, or programmable or dedicated hardware. The storage medium may be a magnetic disk, an optical disk, a read-only memory (ROM), a random access memory (RAM), a flash memory, a hard disk, a solid-state drive, or the like; further, the storage medium may also comprise a combination of the aforementioned types of memories. It can be understood that a computer, a processor, a microprocessor controller, or programmable hardware comprises a storage component that can store or receive software or computer code. When the software or computer code is accessed and executed by the computer, the processor, or the hardware, the method shown in the aforementioned embodiments is implemented.

The embodiments of the present disclosure are described above in conjunction with the accompanying drawings, but the present disclosure is not limited to the specific embodiments described above, the specific embodiments described above are merely illustrative and not limiting, and the person of ordinary skill in the field of the present disclosure, without departing from the purpose of the application and the scope of protection of the claims, may also make many forms, all of which are under the protection of the present disclosure.

Although preferred embodiments of the present disclosure have been described, additional changes and modifications to these embodiments may be made once the basic creative concepts are known to those skilled in the art. The appended claims are therefore intended to be interpreted to comprise preferred embodiments and all changes and modifications falling within the scope of the present disclosure.

Obviously, a person skilled in the art may make various changes and variations to the application without departing from the spirit and scope of the application. Thus, if these modifications and variations of the present disclosure fall within the scope of the claims and their equivalent technologies, the application is also intended to comprise these changes and variations.

What is claimed is:

1. A wireless audio transmission method for a central device, the central device communicating with a peripheral device based on at least one primary transmission link and at least one secondary transmission link within consecutive isochronous intervals, the primary transmission link being configured to transmit a primary audio data stream, the secondary transmission link being configured to transmit a secondary audio data stream, and the primary transmission link having a higher transmission priority than the secondary transmission link, the method comprising:
performing transmission of one or more primary audio data packets based on the primary transmission link within one or more first subevent intervals within a current isochronous interval; and
performing transmission of one or more secondary audio data packets based on the secondary transmission link within one or more second subevent intervals within the current isochronous interval, after completing the transmission of the one or more primary audio data packets and upon determining that the current isochronous interval has one or more remaining time slots;
wherein the one or more primary audio data packets are audio data packets within the primary audio data stream, the one or more secondary audio data packets are audio data packets within the secondary audio data stream; and
wherein the one or more first subevent intervals and the one or more second subevent intervals at least partially overlap in the time domain.

2. The method according to claim 1, wherein each of the first subevent intervals comprises a first transmission time slot, a first reception time slot, a first time of inter-frame space, and a first time of minimum slot space for the central device on the primary transmission link;
each of the second subevent interval comprises a second transmission time slot, a second reception time slot, a second time of inter-frame space interval, and a second time of minimum slot space for the central device on the secondary transmission link; and
an offset value of the secondary transmission link is greater than or equal to a sum of a duration of the first subevent interval and an offset value of the primary transmission link.

3. The method according to claim 2, wherein the duration of the first subevent interval equals the duration of the second subevent interval; and
the primary transmission link and the secondary transmission link are both CIS (Connected Isochronous Stream) links.

4. The method according to claim 1, further comprising:
acquiring an audio data stream to be transmitted;
performing lossy compression encoding on the audio data stream to obtain the primary audio data stream comprising the primary audio data packet; and
performing lossless encoding on difference data generated after the lossy compression encoding of the audio data stream to obtain the secondary audio data stream comprising the secondary audio data packet.

5. The method according to claim 4, wherein the acquiring an audio data stream to be transmitted comprises: acquiring lossless audio samples, and framing the lossless audio samples to form audio sample frames having an identical length;
the performing lossy compression encoding on the audio data stream to obtain the primary audio data stream comprising the primary audio data packets comprises:
performing lossy compression encoding on the audio sample frames to obtain the primary audio data stream;
the performing lossless encoding on difference data generated after the lossy compression encoding of the audio data stream to obtain the secondary audio data stream comprising the secondary audio data packets comprises:
decoding the primary audio data stream to obtain lossy audio samples, calculating a difference between the lossy audio samples and the lossless audio samples, and performing lossless encoding on the difference to obtain the secondary audio data stream.

6. The method according to claim 1, wherein an asynchronous connection-oriented link is further established between the central device and the peripheral device, the asynchronous connection-oriented link having a lower transmission priority than the secondary transmission link;
wherein, within one isochronous interval, communication with the peripheral device is performed based on the asynchronous connection-oriented link after completing the transmission of the one or more primary audio data packets and the secondary audio data packets, and upon determining that the isochronous interval still has one or more remaining time slots.

7. The method according to any one of claim 1, wherein one isochronous interval is configured with N first subevent intervals; the one or more primary audio data packets to be transmitted are stored in a primary buffer;
the completing the transmission of the one or more primary audio data packets within the current isochronous interval comprises:
acquiring one primary audio data packet from the primary buffer, and transmitting the primary audio data packet within an i-th first subevent interval of the current isochronous interval;
confirming whether the primary audio data packet is correctly received by the peripheral device, and deleting the primary audio data packet from the primary buffer upon correct reception;
confirming whether there are one or more remaining primary audio data packets in the primary buffer, and confirming whether the current isochronous interval has one or more remaining time slots;
transmitting one of the one or more remaining primary audio data packets in the primary buffer within an (i+1)-th first subevent interval of the current isochronous interval if there are one or more remaining primary audio data packets in the primary buffer and the current isochronous interval has one or more remaining first subevent intervals; and
stopping the transmission of the one or more primary audio data packets within the current isochronous interval if there are no remaining primary audio data packets in the primary buffer, or if the i-th first subevent interval is an N-th first subevent interval of the current isochronous interval;
wherein N and i are positive integers, and i is less than or equal to N.

8. The method according to claim 1, wherein one isochronous interval is configured with M second subevent intervals; the one or more secondary audio data packets to be transmitted are stored in a secondary buffer;
the completing the transmission of the one or more secondary audio data packets within the current isochronous interval comprises:
determining that a j-th second subevent interval within the current isochronous interval can be used to transmit the secondary audio data packet based on one or more remaining time slots of the current isochronous interval and an offset value of the secondary transmission link after completing the transmission of the one or more primary audio data packets;
acquiring one secondary audio data packet from the secondary buffer, and transmitting the secondary audio data packet within the j-th second subevent interval;
confirming whether the secondary audio data packet is correctly received by the peripheral device, and deleting the secondary audio data packet from the secondary buffer upon correct reception;
confirming whether there are one or more remaining secondary audio data packets in the secondary buffer, and confirming whether the current isochronous interval has one or more remaining time slots;
transmitting one of the one or more remaining secondary audio data packets in the secondary buffer within a (j+1)-th second subevent interval of the current isochronous interval if there are one or more remaining secondary audio data packets in the secondary buffer and the current isochronous interval has one or more remaining second subevent intervals; and
stopping the transmission of one or more secondary audio data packets within the current isochronous interval if there are no remaining secondary audio data packets in the secondary buffer, or if the j-th second subevent interval is an M-th second subevent interval of the current isochronous interval;
wherein M and j are positive integers, and j is less than or equal to M.

9. A wireless audio transmission method for a peripheral device, the peripheral device communicating with a central device based on at least one primary transmission link and at least one secondary transmission link within consecutive isochronous intervals, the primary transmission link being configured to transmit a primary audio data stream, the secondary transmission link being configured to transmit a secondary audio data stream, and the primary transmission link having a higher transmission priority than the secondary transmission link, the method comprising:
receiving one or more primary audio data packets transmitted by the central device based on the primary transmission link within one or more first subevent intervals within a current isochronous interval; and
receiving one or more secondary audio data packets transmitted by the central device based on the secondary transmission link within one or more second subevent intervals within the current isochronous interval after completing reception of the one or more primary audio data packets and upon determining that the current isochronous interval has one or more remaining time slots;
wherein the one or more primary audio data packets are audio data packets within the primary audio data stream, the one or more secondary audio data packets are audio data packets within the secondary audio data stream; and
wherein the one or more first subevent intervals and the one or more second subevent intervals at least partially overlap in the time domain.

10. The method according to claim 9, wherein one first subevent interval comprises a third reception time slot, a third transmission time slot, a first time of inter-frame space, and a first time of minimum slot space for the peripheral device on the primary transmission link;
one second subevent interval comprises a fourth reception time slot, a fourth transmission time slot, a second time of inter-frame space interval, and a second time of minimum slot space for the peripheral device on the secondary transmission link; and
an offset value of the secondary transmission link is greater than or equal to a sum of a duration of the first subevent interval and an offset value of the primary transmission link.

11. The method according to claim 9, wherein the primary audio data packets carry audio data encoded with lossy compression, and the secondary audio data packets carry losslessly encoded difference data corresponding to the primary audio data packets;
the method further comprises:
decoding the primary audio data packets to obtain primary audio samples, losslessly decoding the corresponding secondary audio data packets to obtain secondary audio samples, and performing a summation calculation on the primary audio samples and the secondary audio samples to output lossless audio if all the primary audio data packets and all the secondary audio data packets respectively corresponding thereto are correctly received within a predetermined duration;
decoding the primary audio data packets to obtain primary audio samples, obtaining secondary audio samples corresponding to the primary audio data packets through lossless decoding and packet loss concealment techniques, performing a summation calculation on the primary audio samples and the secondary audio samples to output repaired lossless audio if all the primary audio data packets are correctly received within a predetermined duration, but only secondary audio data packets corresponding to a portion of the primary audio data packets are correctly received, and upon determining that a packet loss probability of the secondary audio data packets is less than or equal to a predetermined value;
decoding the primary audio data packets to obtain primary audio samples, and outputting the primary audio samples if all the primary audio data packets are correctly received within a predetermined duration, but only secondary audio data packets corresponding to a portion of the primary audio data packets are correctly received, and upon determining that the packet loss probability of the secondary audio data packets is greater than the predetermined value; and
obtaining repaired primary audio samples through decoding and packet loss concealment techniques, and outputting the repaired primary audio samples if only a portion of the primary audio data packets are correctly received within the predetermined duration.

12. The method according to claim 8, wherein an asynchronous connection-oriented link is further established between the peripheral device and the central device, the asynchronous connection-oriented link having a lower transmission priority than the secondary transmission link;
wherein, within the current isochronous interval, communication with the central device is performed based on the asynchronous connection-oriented after completing the reception of the one or more primary audio data packets and the secondary audio data packets, and upon determining that the isochronous interval still has one or more remaining time slots.

13. The method according to claim 8, wherein one isochronous interval is configured with N first subevent intervals;
the completing the reception of the one or more primary audio data packets within the current isochronous interval comprises:
receiving one primary audio data packet transmitted by the central device within an i-th first subevent interval of the current isochronous interval;
confirming whether there are more primary audio data packets to be received within the current isochronous interval, and confirming whether the current isochronous interval has one or more remaining time slots;
receiving one primary audio data packet transmitted by the central device within an (i+1)-th first subevent interval of the current isochronous interval if there are more primary audio data packets to be received within the current isochronous interval and the current isochronous interval has one or more remaining first subevent intervals; and
stopping the reception of the one or more primary audio data packets within the current isochronous interval if there are no more primary audio data packets to be received within the current isochronous interval, or if the i-th first subevent interval is an N-th first subevent interval of the current isochronous interval;
wherein N and i are positive integers, and i is less than or equal to N.

14. The method according to claim 8, wherein one isochronous interval is configured with M second subevent intervals;
the completing the reception of the one or more secondary audio data packets within the current isochronous interval comprises:
determining that a j-th second subevent interval within the current isochronous interval can be used to receive one secondary audio data packet based on remaining time slots of the current isochronous interval and an offset value of the secondary transmission link after completing the reception of the one or more primary audio data packets;
receiving one secondary audio data packet within the j-th second subevent interval;
confirming whether there are more secondary audio data packets to be received within the current isochronous interval, and confirming whether the current isochronous interval has one or more remaining time slots;
receiving one secondary audio data packet within a (j+1)-th second subevent interval of the current isochronous interval if there are more secondary audio data packets to be received within the current isochronous interval and the current isochronous interval has one or more remaining second subevent intervals; and
stopping the reception of the one or more secondary audio data packets within the current isochronous interval if there are no more secondary audio data packets to be received within the current isochronous interval, or if the j-th second subevent interval is an M-th second subevent interval of the current isochronous interval;
wherein M and j are positive integers, and j is less than or equal to M.

15. A central device, communicating with a peripheral device based on at least one primary transmission link and at least one secondary transmission link within consecutive isochronous intervals, the primary transmission link being configured to transmit a primary audio data stream, the secondary transmission link being configured to transmit a secondary audio data stream, and the primary transmission link having a higher transmission priority than the secondary transmission link, the central device comprising:
a first primary audio data stream transmission unit, configured to perform transmission of one or more primary audio data packets based on the primary transmission link within one or more first subevent intervals within a current isochronous interval; and
a first secondary audio data stream transmission unit, configured to perform transmission of one or more secondary audio data packets based on the secondary transmission link within one or more second subevent intervals of the current isochronous interval after the first primary audio data stream transmission unit completes the transmission of the one or more primary audio data packets and upon determining that the current isochronous interval has one or more remaining time slots;
wherein the one or more primary audio data packets are audio data packets within the primary audio data stream, the one or more secondary audio data packets are audio data packets within the secondary audio data stream; and
wherein the one or more first subevent intervals and the one or more second subevent intervals at least partially overlap in the time domain.

16. The central device according to claim 15, further comprising an encoder, the encoder is configured to:
receive an audio data stream to be transmitted;
perform lossy compression encoding on the audio data stream to obtain the primary audio data stream comprising the primary audio data packets, and output it to the first primary audio data stream transmission unit; and
perform lossless encoding on difference data generated after the lossy compression encoding of the audio data stream to obtain the secondary audio data stream comprising the secondary audio data packets, and output it to the first secondary audio data stream transmission unit.

17. The central device according to claim 16, wherein the encoder comprises a framing unit, a first lossy encoding unit, a first decoding unit, a difference calculation unit, and a lossless encoding unit;
the framing unit is configured to receive lossless audio samples of the audio data stream to be transmitted, and frame the lossless audio samples to form audio sample frames having an identical length;
the first lossy encoding unit is configured to receive the audio sample frames from the framing unit, perform lossy compression encoding on the audio sample frames, and output a result as the primary audio data stream;
the first decoding unit is configured to receive the primary audio data stream from the first lossy encoding unit, decode the primary audio data stream, and output lossy audio samples;
the difference calculation unit is configured to receive the audio sample frames from the framing unit and the lossy audio samples from the first decoding unit, and calculate a difference between the lossy audio samples and the lossless audio samples; and
the lossless encoding unit is configured to perform lossless encoding on the difference calculated by the difference calculation unit, and output a result as the secondary audio data stream.

18. A peripheral device, configured for communicating with a central device based on at least one primary transmission link and at least one secondary transmission link within consecutive isochronous intervals, the primary transmission link being configured to transmit a primary audio data stream, the secondary transmission link being configured to transmit a secondary audio data stream, and the primary transmission link having a higher transmission priority than the secondary transmission link, the peripheral device comprising:
a second primary audio data stream transmission unit, configured to receive one or more primary audio data packets transmitted by the central device based on the primary transmission link within one or more first subevent intervals within a current isochronous interval; and
a second secondary audio data stream transmission unit, configured to receive one or more secondary audio data packets transmitted by the central device, based on the secondary transmission link within one or more second subevent intervals of the current isochronous interval after the primary audio data stream transmission unit completes the reception of the one or more primary audio data packets and upon determining that the current isochronous interval has one or more remaining time slots;
wherein the one or more primary audio data packets are audio data packets within the primary audio data stream, the one or more secondary audio data packets are audio data packets within the secondary audio data stream; and
wherein the one or more first subevent intervals and the one or more second subevent intervals at least partially overlap in the time domain.

19. The peripheral device according to claim 18, further comprising a decoder;
the primary audio data packets carry audio data encoded with lossy compression, and the secondary audio data packets carry losslessly encoded difference data corresponding to the primary audio data packets;
the decoder comprises a second decoding unit, a lossless decoding unit, and a summation calculation unit;
the second decoding unit is configured to decode received primary audio data packets and output primary audio samples;
the lossless decoding unit is configured to losslessly decode received secondary audio data packets corresponding to the primary audio data packets and output secondary audio samples; and
the summation calculation unit is configured to perform a summation calculation on the primary audio samples and the secondary audio samples and output lossless audio.

20. The peripheral device according to claim 18, wherein:
each of the first subevent intervals comprises a first transmission time slot, a first reception time slot, a first time of inter-frame space, and a first time of minimum slot space for the central device on the primary transmission link;
each of the second subevent interval comprises a second transmission time slot, a second reception time slot, a second time of inter-frame space interval, and a second time of minimum slot space for the central device on the secondary transmission link; and
an offset value of the secondary transmission link is greater than or equal to a sum of a duration of the first subevent interval and an offset value of the primary transmission link.
